(19) United States
(12) Patent Application Publication
(10) Pub. No.: US 2026/0186013 A1
(43) Pub. Date: Jul. 2, 2026

(54) DEVICES, SYSTEMS, AND METHODS FOR DISPOSING SAMPLES ON CARTRIDGES

(71) Applicant: IDEXX LABORATORIES, Inc., Westbrook, ME (US)

(72) Inventors: Michael Stone, Falmouth, ME (US); Justin Griffin, Scarborough, ME (US)

(21) Appl. No.: 19/425,174

(22) Filed: Dec. 18, 2025

Related U.S. Application Data
(60) Provisional application No. 63/739,346, filed on Dec. 27, 2024.

(51) Int. Cl. G01N 35/10; B01L 3/02

(52) U.S. Cl. CPC G01N 35/1009; B01L 3/0241; B01L 2300/021; B01L 2300/042; B01L 2300/047; B01L 2300/0645; B01L 2300/0672; B01L 2300/123; B01L 2400/0427; G01N 2035/1037

(57) ABSTRACT

A method for displacing a biological sample into a sample reservoir of a cartridge is disclosed. The method includes: (i) receiving the biological sample in a receiving chamber, wherein the receiving chamber is configured to receive the biological sample via at least one receiving portion, and wherein the receiving chamber comprises a fluidic communication mechanism between the receiving chamber and the sample reservoir; (ii) actuating an actuation mechanism of an actuation cap in a first direction, wherein the actuation cap interfaces with the at least one receiving portion, and wherein the actuation mechanism provides a fluidic communication between the sample reservoir and the receiving chamber when the actuation mechanism is actuated in a first direction; and (iii) based on actuating the actuation mechanism in the first direction, displacing the biological sample from the receiving chamber into the sample reservoir via the fluidic communication mechanism.

### RELATED APPLICATION

This application claims priority to U.S. Provisional Application No. 63/739,346 filed Dec. 27, 2024 which is incorporated herein by reference in its entirety.

### FIELD OF THE DISCLOSURE

The present disclosure involves systems and methods for disposing a biological sample on one or more surfaces of a cartridge. Namely, devices and methods of the disclosure involve one or more components that allow a biological sample to be disposed in one or more reservoirs and then displaced from the one or more reservoirs in a consistent manner onto the one or more surfaces of the cartridge. By disposing the biological sample directly onto the one or more surfaces of the cartridge, any analysis of the biological sample and/or any components of the cartridge and/or analysis of the sample (e.g., via a plurality of particles) may be improved.

### BACKGROUND

Assays (including immunoassays) and other analytical evaluations (e.g., polymerase chain reaction (PCR) tests) can be conducted on one or more portions of a sample utilizing a variety of different methods, including by utilizing a plurality of particles (e.g., paramagnetic, bar-coded beads) and other components of a droplet of the solution containing the sample to assist in performing the assays and other analytical evaluations.

Conventionally, these assays and analytical evaluations have been conducted on preconfigured and prefabricated testing platforms. One such platform includes preconfigured cartridges that utilize a plurality of electrodes to transport individual droplets of a liquid on a surface of the cartridge along one or more paths defined by the plurality of electrodes on one or more surfaces of one or more materials, including a printed circuit board (PCB), semiconductor photolithography, conductive patterning on glass, conductive patterning on ceramic, and/or conductive patterning on plastic, among other possibilities. Such techniques are often referred to as electrowetting on dielectric (“EWOD”).

In some examples, a plurality of particles (e.g., paramagnetic, bar-coded beads), can be suspended within a solution on the surface of an EWOD cartridge that can be used for testing and identification of components in the solution and/or a portion thereof (e.g., a particular type of paramagnetic, bar-coded bead). To increase the accuracy of assay test results, it is desirable to, prior to testing, ensure that the plurality of particles (e.g., paramagnetic, bar-coded beads) are properly dispersed throughout the solution and properly transported and/or manipulated (e.g., immobilized) during the mixing of the components of the assay, as well as during readings of the resultant solution.

When a sample resides in a prepared droplet of solution for too long prior to testing, the homogeneity and number of particles throughout the area to be imaged and/or otherwise analyzed (e.g., the read area) may be inconsistent and any resultant analysis of the droplet (or components therein) may be inaccurate. Further, this inconsistency may be due, at least in part, to the particles becoming less homogenized and/or dispersed throughout the droplet (e.g., by settling to the bottom and/or edges of the droplet, clumping together or both, among other potential issues), as well as one or more issues that involve lighting and/or other factors that denigrate the quality and/or consistency of imaging and/or other analytical protocols of the particles. Accordingly, preparations and/or imaging of the sample (e.g., via the droplet and the components thereof) are subject to variability between testing runs and/or operators and, thus, degrade the accuracy and precision of any associated testing results (e.g., assay results).

As such, in examples, there exists a need for samples (e.g., biological testing samples) to be disposed onto one or more surfaces of a cartridge (e.g., an EWOD cartridge). In examples, if the sample could be disposed on one or more surfaces of a cartridge (e.g., an EWOD cartridge), in a consistent, timely, and repeatable manner, then any resulting analysis of the sample would be improved.

### SUMMARY

In an example, a cartridge is described. In examples, the cartridge comprises a sample reservoir. In examples, the cartridge further comprises a receiving chamber, wherein the receiving chamber is configured to receive a biological sample via at least one receiving portion, and wherein the receiving chamber comprises a fluidic communication mechanism between the receiving chamber and the sample reservoir. In examples, the cartridge further comprises an actuation cap, wherein the actuation cap interfaces with the at least one receiving portion, and wherein the actuation cap comprises an actuation mechanism, and wherein the actuation mechanism provides a fluidic communication between the sample reservoir and the receiving chamber when the actuation mechanism is actuated in a first direction.

In another example, an example method for displacing a biological sample into a sample reservoir of a cartridge is described. In examples, the method comprises: (i) receiving the biological sample in a receiving chamber, wherein the receiving chamber is configured to receive the biological sample via at least one receiving portion, and wherein the receiving chamber comprises a fluidic communication mechanism between the receiving chamber and the sample reservoir, (ii) actuating an actuation mechanism of an actuation cap in a first direction, wherein the actuation cap interfaces with the at least one receiving portion, and wherein the actuation mechanism provides a fluidic communication between the sample reservoir and the receiving chamber when the actuation mechanism is actuated in a first direction, and (iii) based on actuating the actuation mechanism in the first direction, displacing the biological sample from the receiving chamber into the sample reservoir via the fluidic communication mechanism.

In another example, a tangible non-transitory computer-readable medium is described, having stored thereon program instructions that, upon execution by a controller cause a controller to perform a set of operations. In examples, the set of operations comprises (i) receiving a biological sample in a receiving chamber of a cartridge, wherein the receiving chamber is configured to receive the biological sample via at least one receiving portion, and wherein the receiving chamber comprises a fluidic communication mechanism between the receiving chamber and a sample reservoir of the cartridge, (ii) actuating an actuation mechanism of an actuation cap of the cartridge in a first direction, wherein the actuation cap interfaces with the at least one receiving portion, and wherein the actuation mechanism provides a fluidic communication between the sample reservoir and the receiving chamber when the actuation mechanism is actuated in a first direction, and (iii) based on actuating the actuation mechanism in the first direction, displacing the biological sample from the receiving chamber into the sample reservoir via the fluidic communication mechanism.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates a cartridge, according to an example embodiment.

FIG. 2B illustrates an alternate view of one or more components of the cartridge of FIG. 2A, according to an example embodiment.

FIG. 2C illustrates an alternate view of one or more components of the cartridge of FIGS. 2A-2B, according to an example embodiment.

FIG. 2D illustrates an alternate view of one or more components of the cartridge of FIGS. 2A-2B, according to an example embodiment.

FIG. 2E illustrates an alternate view of one or more components of the cartridge of FIGS. 2A-2D, according to an example embodiment.

FIG. 2F illustrates a cross-sectional view of one or more components of the cartridge of FIGS. 2A-2E, according to an example embodiment.

FIG. 2G illustrates an alternative view of one or more components of the cartridge of FIGS. 2A-2F, according to an example embodiment.

FIG. 2H illustrates a cross-sectional view of a section of one or more components of the cartridge of FIGS. 2A-2G, according to an example embodiment.

FIG. 2I illustrates a cross-sectional view of a section of one or more components of the cartridge of FIGS. 2A-2G, according to an example embodiment.

FIG. 3 illustrates a computing system configured for use with an imaging device and a mobile computing device, according to an example embodiment.

FIG. 4 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the disclosure is directed to devices and methods for disposing and/or displacing a biological sample onto one or more surfaces and/or into one or more reservoirs of a cartridge. In examples, these samples may interact with a plurality of particles (e.g., one or more types of paramagnetic, bar-coded beads) containing one or more identifying features (such as a unique bar code, a responsive wavelength (e.g., in PCR testing), a color, a shape, an alphanumeric symbol, and/or the like). These particles include one or more of the following: microbeads, microparticles, micropellets, microwafers, microparticles containing one or more identifying features (such as a bar code, a responsive wavelength (e.g., in PCR testing), a color, a shape, an alphanumeric symbol, and/or the like), paramagnetic microparticles, paramagnetic microparticles containing one or more bar codes, and/or beads containing one or more bar codes. Moreover, the particles may be magnetic or paramagnetic. Particles suitable for use in the disclosure are capable of attachment to other substances such as derivatives, linker molecules, proteins, nucleic acids, or combinations thereof. The capability of the particles to be attached to other substances can result from the particle material as well as from any further surface modifications or functionalization of the particle. The particles can be functionalized or be capable of becoming functionalized in order to covalently or non-covalently attach proteins, nucleic acids, linker molecules or derivatives as described herein.

For example, the surface of these particles (e.g., paramagnetic, bar-coded beads), can be modified or functionalized with amine, biotin, streptavidin, avidin, protein A, sulfhydryl, hydroxyl and carboxyl. These particles may be spherical or other shapes, may be light transmissive and may be digitally coded such as for example, by an image that provides for high contrast and high signal-to-noise optical detection to facilitate identification of the bead. To the extent an image is present, the image may be implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), and the code represented by the image on the coded bead can be decoded. Various code patterns, such as circular, square, or other geometrical shapes, can be designed as long as they can be recognized by an optical decoder. Examples of these one or more types of particles may be found at: U.S. Pat. Nos. 7,745,091, 8,148,139, and 8,614,852.

Additionally or alternatively, these particles (e.g., paramagnetic, bar-coded beads) may comprise one or more materials, including one or more of the following: glass, polymers, polystyrene, latex, elemental metals, ceramics, metal composites, metal alloys, silicon, or of other support materials such as agarose, ceramics, glass, quartz, polyacrylamides, polymethyl methacrylates, carboxylate modified latex, melamine, and Sepharose, and/or one or more hybrids thereof. In particular, useful commercially available materials include carboxylate modified latex, cyanogen bromide activated Sepharose beads, fused silica particles, isothiocyanate glass, polystyrene, and carboxylate monodisperse microspheres. Furthermore, these particles also comprise one or more specific shapes, dimensions, and/or configurations and may be modified for one or more specific uses. For example, these particles (e.g., paramagnetic, bar-coded beads) may be a variety of sizes from about 0.1 microns to about 100 microns, for example about 0.1, 0.5, 1.0, 5, 10, 20, 30, 40 50, 60, 70, 80 90 or 100 microns. In a further aspect, these particles may be surface modified and/or functionalized with biomolecules for use in biochemical analysis.

The particles of the disclosure may be used in various homogenous, sandwich, competitive, or non-competitive assay formats to generate a signal that is related to the presence or amount of an analyte in a test sample. The term “analyte,” as used herein, generally refers to the substance, or set of substances in a sample that are detected and/or measured, either directly or indirectly. In various aspects, the assays of the disclosure include sandwich immunoassays that capture an analyte in a sample between a binding member (e.g., antibody) attached to the particles and a second binding member for the analyte that is associated with a label. In another example embodiment, the binding member on the particles may be an antigen (e.g., protein) that binds an antibody of interest in a patient sample in order to capture the antibody on the particle. The presence of the antibody can then be detected with a label conjugated to a second binding member specific for an antibody. The second binding member attached to the label may be the antigen conjugated to the label or the binding member may itself be an antibody (e.g., anti-species antibody) that is conjugated to the label. In example embodiments, these characteristics may be referred to herein as a “unique identifying feature” and/or “parameter” of the particles and/or of the droplet in which the particles reside. Other examples are possible.

For example, the particles may be imaged and/or otherwise analyzed while the particles are illuminated or partially illuminated to better identify a “unique identifying feature” and/or “parameter” of the particles under one or more appropriate lighting sources (e.g., a fluorescent, brightfield, and/or ultraviolet lighting). In some examples, this light illumination may be undertaken via sidelighting the particles (e.g., via shining a fluorescent and/or brightfield light source on one or more sides of one or more locations of one or more of the particles), among other possibilities. For example, the particles may also bind to a fluorescent tag or label, which may present a “unique identifying feature” and/or “parameter” of the particles to which the fluorescent tag or label might bind and emit one or more responsive signals (e.g., a light signal) under one or more appropriate excitation stimuli (e.g., a fluorescent, brightfield, and/or ultraviolet lighting).

In another example embodiment, the testing protocols of the disclosure are assays, including competitive immunoassays for detection of antibody in the sample. A competitive immunoassay may be carried out in the following illustrative manner. A sample (e.g. a biological sample from an animal's body fluid, potentially containing an antibody of interest that is specific for an antigen) is contacted with the antigen attached to the particles and with the anti-antigen antibody conjugated to a detectable label. The antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample.

In an alternative example embodiment of a sample, an animal's body fluid, potentially containing an analyte, is contacted with the analyte conjugated to a detectable label and with an anti-analyte antibody attached to the particles. The antigen in the sample competes with analyte conjugated to the label for binding to the antibody attached to the particles. The amount of the label associated with the particles can then be determined after separating unbound antigen and the label. The signal obtained is inversely related to the amount of analyte present in the sample.

Antibodies, antigens, and other binding members may be attached to the particles or to the label directly via covalent binding with or without a linker or may be attached through a separate pair of binding members as is well known (e.g., biotin: streptavidin, digoxigenin: anti-digoxiginen). In addition, while the examples herein reflect the use of immunoassays, the paramagnetic, bar-coded beads and/or particles and methods of the disclosure may be used in other receptor binding assays, including nucleic acid hybridization assays, that rely on immobilization of one or more assay components to a solid phase.

Assays using these samples and/or other assembly components (e.g., particles, solutions, etc.) are often conducted after a series of agitation, assembly, and/or mixing events. In practice, these particles (particularly if they are paramagnetic, bar-coded beads) may bind together in the solution (often referred to as “clumping”) or bind and/or settle on the sides of the solution and/or a surface or container with which the solution is in contact—particularly if the particles are allowed to settle after interacting with the sample, which may contain one or more organic matter components that cause the particles to further bind and/or clump. This binding and/or clumping may result in an inconsistent dispersion of the particles (e.g., paramagnetic, bar-coded beads and/or particles) in the solution. When these particles clump together, they may not be accurately identified or accounted for in the assay.

Additionally, to date, sample preparation and analysis devices, as well as methods for preparing a biological testing sample, require significant manual user handling and input. For example, historically, preparation of a biological sample for testing involves a user (e.g., a clinician) manually measuring and handling the buffer to be mixed with the biological sample. Similarly, the preparation may involve the user manually handling and measuring a liquid reagent to agitate and mix with the liquid diluent and biological sample. This process can be time intensive, result in user error in measurement and handling, and produce waste from these potential user errors. Moreover, handling certain types of crude samples can be particularly problematic. Fecal samples, for instance, can contain harmful pathogens, including bacteria, viruses, and parasites, which can pose health risks to users handling them. As such, fecal samples can contaminate surfaces, equipment, and other samples if not handled properly. This contamination can compromise the accuracy of test results and pose risks to laboratory personnel and others who come into contact with the contaminated items. Additionally, the consistency of fecal samples can vary greatly between samples (e.g., a dehydrated fecal sample, a fluid fecal sample, etc.). Further, fecal samples typically have a strong, unpleasant odor.

The example systems, devices, and methods disclosed herein address some of these issues. An example cartridge of the present disclosure contains a receiving chamber and a sample reservoir (among other chambers), as well as an actuation cap and an actuation mechanism, each of which has a role in preparing a biological sample for testing. In examples, one or more components of these cartridge chambers include one or more compliant materials so that the biological sample can be moved through each of these chambers. In example, this movement may be accomplished by way of protruding a member (e.g., of the actuation mechanism) through the compliant materials (e.g., a septum) and/or by manipulating the compliant materials in one or more additional or alternative fashions (e.g., by compressing and/or pressing an exterior portion of the actuation cap to cause the actuation mechanism to move in a certain direction). Particularly, compression of an actuation mechanism can activate a fluidic communication mechanism to provide a fluidic communication (e.g., one or more fluid paths that are controlled and/or limited by one or more pierceable foils, seals, valves, etc.) to the next chamber. Embodiments can include manual and/or automated actuation.

For instance, the biological sample can be received in a receiving chamber. In examples, the receiving chamber may receive the biological sample via at least one receiving portion. In examples, the receiving chamber may include a fluidic communication mechanism between the receiving chamber and a sample reservoir. In a further aspect, in examples, a user and/or an automated controller may actuate an actuation mechanism of an actuation cap in a particular direction that causes the actuation mechanism to protrude through the fluidic communication mechanism provides a fluidic communication between the receiving chamber and the sample. Thus, in examples, based on actuating the actuation mechanism in the particular direction, the biological sample may be displaced (e.g., due to gravitational forces) from the receiving chamber into the sample reservoir via the fluidic communication mechanism.

Example devices can reduce waste because they receive, meter, and dispose biological samples onto the surface of a cartridge and can provide consistent, efficient, and repeatable analysis of biological samples.

In examples, this arrangement may be useful in integrated cartridge technologies. For instance, the sample reservoir may be disposed on and/or in fluidic communication with one or more other portions of a cartridge that are used for imaging. This integration further limits user interaction with the biological sample and prevents contamination and/or loss of volume of the biological sample. Further, in this manner, the device can prepare the biological sample for a number of different imaging protocols, including on EWOD cartridges and other testing devices and protocols (e.g., a microfluidic assay, a lateral flow assay, an EWOD assay, an assay using bar-coded magnetic beads, etc.).

For example, a cartridge may utilize one or more components to help consistently and efficiently dispose and/or otherwise displace a biological sample into a sample reservoir and/or onto a surface of the cartridge and/or one or more additional or alternative components thereof. To do so, in one example embodiment, the cartridge surface may comprise dielectric materials that transport individual droplets along one or more paths defined by the one or more electrodes on one or more surfaces of one or more materials, including (PCB), semiconductor photolithography, conductive patterning on glass, conductive patterning on ceramic, and/or conductive patterning on plastic, among other possibilities. In example embodiments, the dielectric materials may comprise a hydrophobic material, layer, and/or coating disposed on the surface of the PCB and/or one or more electrodes, the combination of which is referred to herein as the “dielectric surface” and/or a “path” or “paths” along the dielectric surface.

In some embodiments, transportation of the droplets on the cartridge surface can be controlled by a controller and/or other computing devices to create a programmable fluidic path which can be used in number of ways (e.g., to facilitate the performance of an assay and/or immunoassay). Further, because the fluidic movements of the droplets are controlled by a controller and/or other computing device, and programmable, assay protocols and subparts thereof can be finely controlled to meet the needs of the solution mixing, particle assembly, and/or assay, among other parameters.

For example, in some example embodiments, the transportation of the droplets and/or or components thereof may be transported and/or otherwise controlled by one or more sets of a plurality of electrodes that receive an electrical current that mobilize the droplet along one or more specific fluidic paths on the surface of the cartridge (e.g., a dielectric surface of the cartridge). In some examples, a set of electrodes may include a single electrode. In some examples, a set of electrodes may include two or more electrodes. Other examples are possible.

In some examples, one or more electrodes may receive an alternating electrical current (“AC”) at a particular frequency during transportation of the droplet. For example, this particular frequency may be one or more of a variety of frequencies from about 10 hertz to about 100 hertz, for example about 10, 20, 30, 40 50, 60, 70, 80, 90 or 100 hertz. In some examples, the one or more electrodes may receive an alternating electrical current at a particular voltage during transportation of the droplet. For example, this particular voltage may be one or more of a variety of voltages from about 10 volts to about 1000 volts, for example about 10, 50, 100, 200, 300, 400 500, 600, 700, 800, 900, or 1000 volts. Other examples are possible.

For example, in some embodiments, the droplets and/or or components thereof may be transported along one or more specific fluidic paths on the surface of the cartridge. In some examples, the one or more sets of electrodes may cause the droplet to be transported along a first, substantially linear fluidic path on the surface of the cartridge at a first transport speed and then cause the droplet to be transported along a second, substantially linear fluidic path on the surface of the cartridge that is of a specific orientation to the first substantially linear fluidic path at a second transport speed. In example embodiments, if the droplet does not reside in one location on the cartridge surface for more than a threshold amount of time, then the kinetics of being transported along the first and/or second substantially linear fluidic paths may impart a mechanical action on the droplet and/or the components thereof during transportation of the droplet. For example, in some embodiments, if the first and second substantially linear fluidic paths are perpendicular to each other, and the transport speed of the droplet is the same or similar along each fluidic path, then the droplet and the components thereof will be imparted with a mechanical action caused by the momentum of the droplet and/or the components taking a 90 degree turn during transportation of the droplet. This mechanical action may cause, among other things, the components of the droplet (e.g., a plurality of particles in the droplet) to move and/or otherwise disperse throughout the droplet. Other examples are possible.

In some examples, one or more electrodes may cause the droplet to be transported along a first, substantially linear fluidic path on the surface of the cartridge at a first transport speed and then cause the droplet be transported along a second, non-linear fluidic path on the surface of the cartridge that is of a specific configuration and/or orientation to the first substantially linear fluidic path at a second transport speed. For example, in some embodiments, if the first substantially linear fluidic path is connected to a particularly configured second, substantially rectangular fluidic path, and the transport speed of the droplet is the same or similar along each fluidic path, then the droplet and the components thereof will be imparted with a mechanical action caused by the momentum of the droplet and/or the components during transportation of the droplet. This mechanical action may cause, among other things, the components of the droplet (e.g., a plurality of particles in the droplet) to move and/or otherwise disperse throughout the droplet. Other example non-linear paths include: substantially square paths, substantially circular paths, substantially triangular paths, substantially pentagonal paths, substantially hexagonal paths, substantially heptagonal paths, substantially octagonal paths, and substantially decagonal paths, among others. Other examples are possible.

For example, in some example embodiments, the manipulation of the droplets and/or or components thereof may be manipulated and/or otherwise controlled by one or more electrodes that receive an electrical current that manipulates (e.g., immobilizes) the droplet at one or more specific locations along the fluidic paths on the surface of the cartridge (e.g., a dielectric surface of the cartridge). In some examples, the one or more electrodes may receive a direct electrical current (“DC”) that immobilizes the droplet and/or the components thereof during testing and/or analysis.

In some examples, this manipulation (e.g., immobilization) may occur at a particular location on the cartridge. In some examples, this manipulation may occur at a testing location on the surface of the cartridge. In some examples, particularly if the droplet and/or the components thereof have magnetic or paramagnetic properties, if one or more electrodes receive a direct electrical current, then the droplet and/or the components may align and/or otherwise be oriented in one or more particular orientations during testing and/or analysis (e.g., due to the DC creating a magnetic field in one or more particular directions). In some examples, the one or more sets of electrodes may also receive an alternating electrical current (“AC”) at a particular frequency during manipulation of the droplet.

In an example embodiment, in addition to controlling the transportation and/or manipulation (e.g., immobilizing) of the droplet on the surface of the cartridge, various antibodies, antigens, and/or other components may also be controlled, mixed, transported, and/or immobilized on the surface of the cartridge. Using this programmable protocol, antibodies, antigens, and/or other components may be adhered onto one or more surfaces of the plurality of particles (e.g., paramagnetic, bar-coded beads), which are referred to herein as the “assembled particles”. In a further aspect, one or more analyses may be performed on the assembled particles on the surface of the cartridge. In this regard, a user of the cartridge can perform complicated, often multi-step protocols, which are often spread over several machines and devices at various stages of the multi-step protocols, in a single cartridge and a single instrument/device. In one example embodiment, a multiplex multiple analyte targets in a single reaction may be performed on a droplet on the surface of the cartridge detailed above, instead of using multiple devices (e.g., shaker plates, pipettes, vials, plates with multiple wells, plate readers, cameras, etc.). In one example embodiment, a multiplex (i.e. multiple analyte targets in a single reaction) may be performed on a droplet in a portion of the surface of the cartridge comprising a single electrode. Other examples are possible.

In some embodiments, it is beneficial to immobilize the droplet and/or components thereof (e.g., paramagnetic, bar-coded beads) for one or more steps in an assay. In some embodiments, as described above, immobilization of the droplets on the cartridge surface can be controlled by applying an electrical current (e.g., a direct electrical current) to one or more electrodes of the cartridge. In some embodiments, immobilization of the droplet and/or components thereof (e.g., paramagnetic, bar-coded beads) on the cartridge surface can also be controlled by the at least one magnet. In some example embodiments, the at least one magnet may be a permanent or semi-permanent magnet below or above one or more portions of the cartridge surface. In other embodiments, the at least one magnet may be an electric magnet configured to interact with the droplet and/or components thereof (e.g., paramagnetic, bar-coded beads) via a controller and/or other computing devices to create a programmable interaction along the fluidic path to promote assay protocols and subparts thereof.

In other examples, after one or more binding members have attached to the particles (e.g., paramagnetic, bar-coded beads), the solution surrounding the particles may be removed and the particles with attached binding members (collectively referred to herein as “assembled particles”) may be washed in preparation for testing. In an example embodiment, during this washing portion, one or more components may be used to facilitate the washing, including one or more components of a cartridge to manipulate (e.g., immobilize) the assembled particles in one or more portions of the cartridge. For example, because the assembled particles may have magnetic or paramagnetic properties, an electrical current and/or a magnet may be used to secure the assembled particles in a portion of the cartridge while a washing solution is dispersed into the cartridge to improve the results of the washing portion (e.g., by ensuring that the assembled particles remain intact and in a specific portion of the cartridge). Other improvements may be realized.

In this regard, by combining the technologies of the receiving chamber, the fluidic communication mechanism, the actuation cap, the actuation mechanism, and other components of the cartridge, with EWOD, magnetic, and particle technologies (e.g., paramagnetic, bar-coded bead technologies), the concepts described herein provide disclosure for a compact, in clinic, instrument with multiplex capability that allow the mixing and manipulation of solutions, samples, and particles (including paramagnetic, bar-coded beads) on the surface of the cartridge. In an example embodiment, by leveraging these technologies, a platform is described that can have the same convenience as other tabletop devices (e.g., a SNAP® reader and device) but with the increased menu of capabilities for laboratory testing and assay protocols, including multi-part assays (e.g., multiplex lab tests), without the inconvenience and costs of the devices, instruments, and operators typically required for these tests and assays (e.g., liquid handling robots, plates, plate washers, and/or specialized plate readers). Further, in example embodiments, because multiple tests and assays may be completed on one or more small sample sizes (e.g., one or more droplets containing assembled paramagnetic, bar-coded beads), the present disclosure allows complex analysis (e.g., of multiple analytes) based on small volumes of samples, which is beneficial in instances where sample volume is an issue.

In one example, a user may add a biological sample (e.g., a fecal sample, urine sample, blood sample, etc.) into a receiving portion (e.g., an opening) of a receiving chamber of the cartridge, insert an actuation cap into the receiving portion, press an actuation mechanism of the actuation cap in a first direction (e.g., downward toward the receiving chamber), and pierce a fluidic communication mechanism (e.g., a septum, a pierceable foil) with the actuation mechanism, thereby allowing the biological sample to be displaced from the receiving chamber of the cartridge to a sample reservoir of the cartridge—allow without the user ever touching the biological sample or having to manually dispose, measure, or meter the biological sample into the sample reservoir. Then, in examples, the user may insert a cartridge into a tabletop instrument/device, and allow the instrument/device to add and/or control other components (e.g., paramagnetic, bar-coded beads, solution, antibodies, etc.) on the cartridge, and analyze one or more components to provide one or more results to clinician, physician, and/or patient based on the same, all using the same sample, cartridge and instrument/device. Importantly, once the user inserts the cartridge into the tabletop instrument device, some (or all) of the fluidics, manipulation of the components in the cartridge (including the paramagnetic, bar-coded beads), illumination of the particles, and the eventual imaging and/or reading of these components are all automated, controlled, and finely-tuned by program instructions executing on a computing device, all of which may be accomplish without user interaction or control.

In another example, a user may add a biological sample (e.g., a fecal sample, urine sample, blood sample, etc.) into a receiving portion (e.g., an opening) of a receiving chamber of the cartridge, and insert an actuation cap into the receiving portion. Then, in examples, the user may insert a cartridge into a tabletop instrument/device, and allow the instrument/device to press an actuation mechanism of the actuation cap in a first direction (e.g., downward toward the receiving chamber), and pierce a fluidic communication mechanism (e.g., a septum, a pierceable foil) with the actuation mechanism, thereby allowing the biological sample to be displaced from the receiving chamber of the cartridge to a sample reservoir of the cartridge. The instrument/device can then also add and/or control other components (e.g., paramagnetic, bar-coded beads, solution, antibodies, etc.) on the cartridge, and analyze one or more components to provide one or more results to clinician, physician, and/or patient based on the same, all using the same sample, cartridge and instrument/device. Importantly, once the user inserts the cartridge into the tabletop instrument device, some (or all) of the fluidics, manipulation of the components in the cartridge (including the paramagnetic, bar-coded beads), illumination of the particles, and the eventual imaging and/or reading of these components are all automated, controlled, and finely-tuned by program instructions executing on a computing device, all of which may be accomplish without user interaction or control.

By doing so, several benefits are realized, including users (e.g., clinicians) having the same high throughput/multiplexing capability of the traditional technologies without the required overhead (or error) of a user controlling or coordinating every step of the process or the multitude of separate devices and components required to accomplish the tests and/or assays. Time to result would also be improved, instead of sending samples to a lab and waiting for a prolonged period of time for results (sometimes several days), users could have results in a matter of minutes, and all while using a single sample on a single cartridge in connection with a single device. This improved time to result also improves the ability for a treating physician and/or patient to receive results in a more timely manner (e.g., results could be shared with the patient during the visit) and make more timely decisions based thereon.

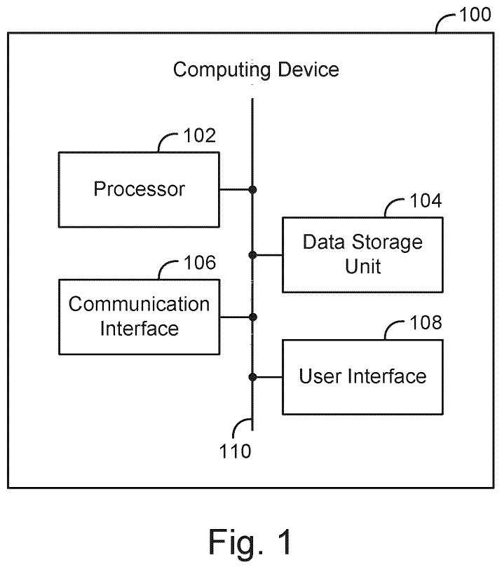

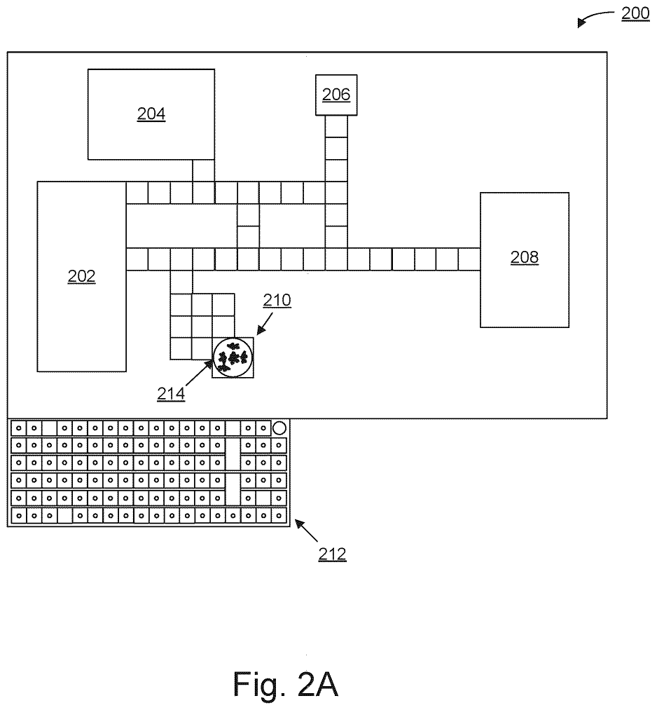

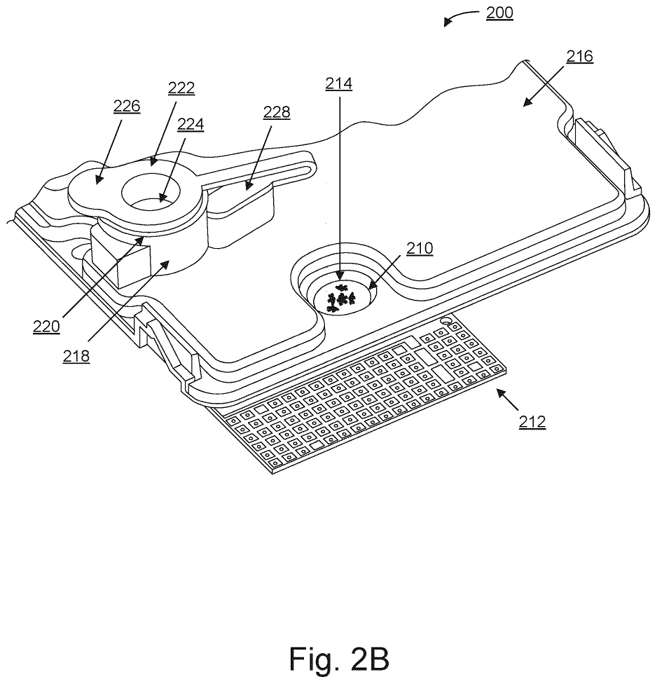

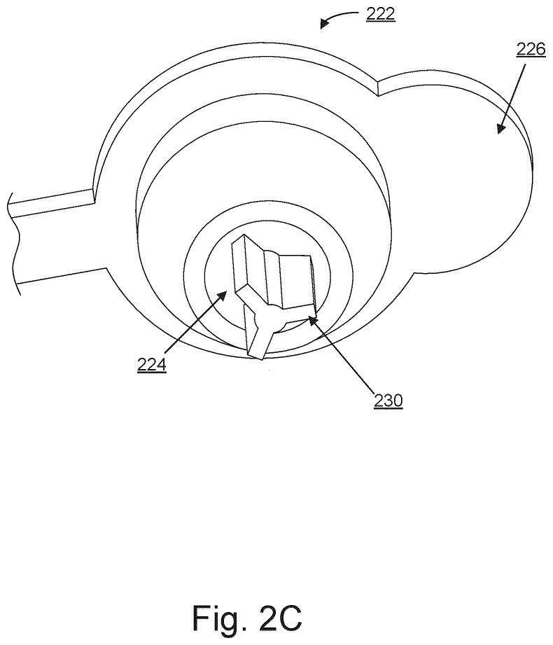

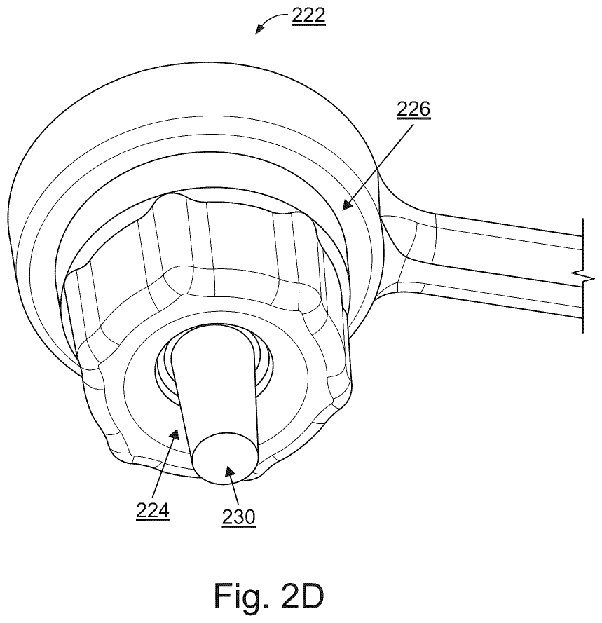

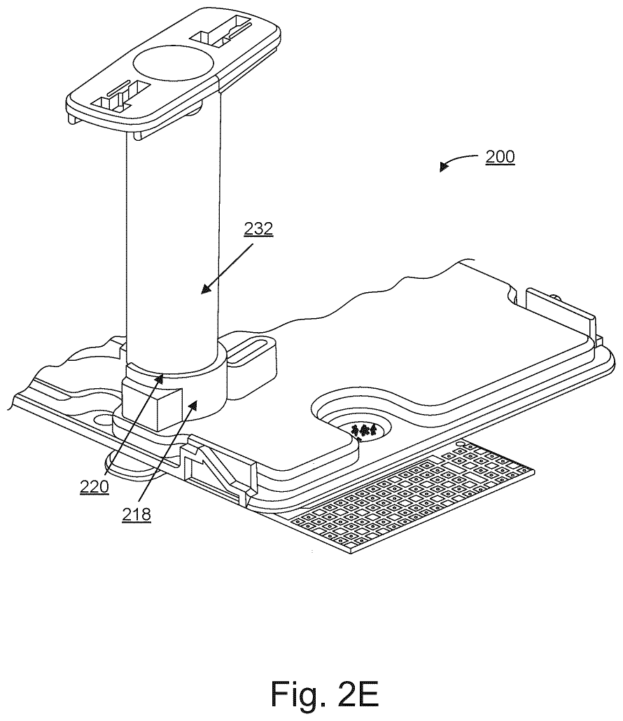

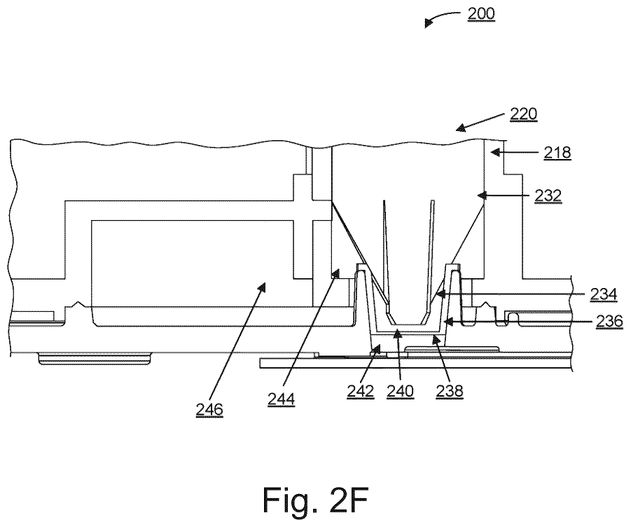

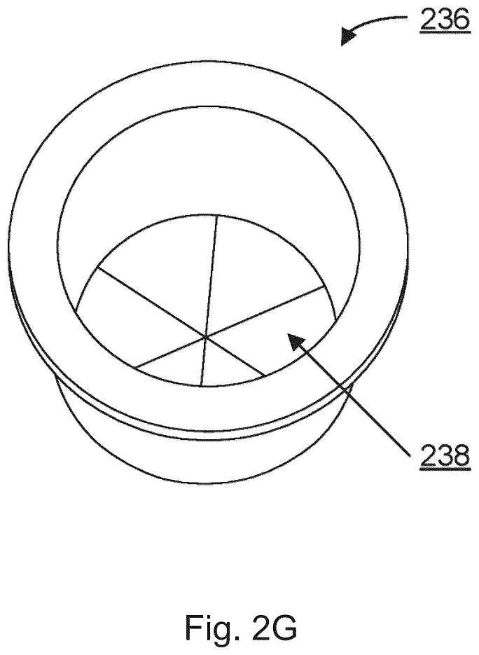

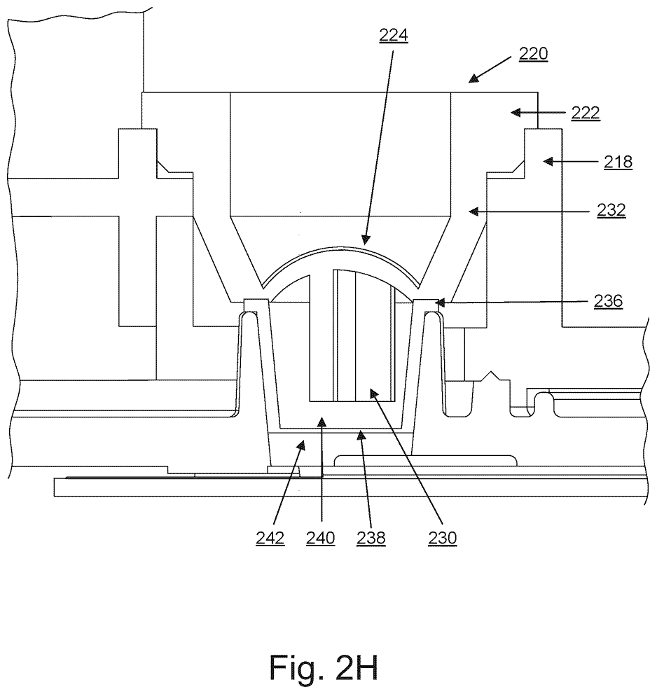

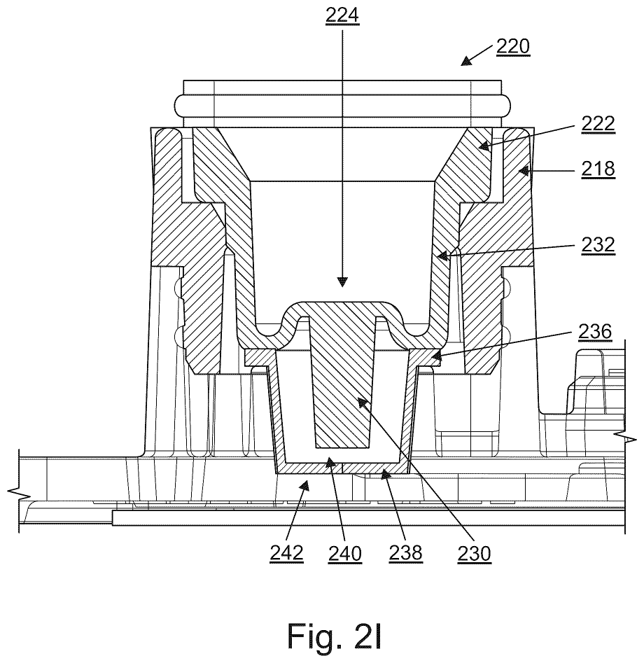

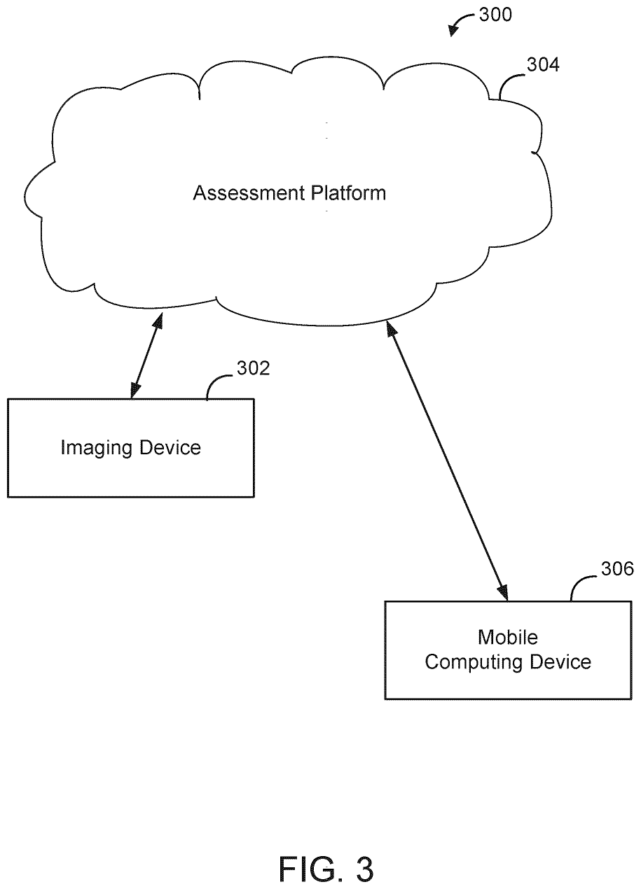

Referring now to the figures, FIG. 1 is a simplified block diagram of an example computing device 100 of a system (e.g., those illustrated in FIGS. 2A-3, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (DSP)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIG. 2A, an example cartridge 200 is disclosed, which includes a sample reservoir 202, a solution reservoir 204, an assay component reservoir 206, a waste reservoir 208, and a testing location 210, all of which reside on a dielectric cartridge surface, as well as a connection mechanism 212, according to the illustrated example embodiment. In this example embodiment, one or more sets of a plurality of electrodes are disposed along various portions of dielectric cartridge surface, including in the illustrated plurality of paths that connect testing location 210 to sample reservoir 202, a solution reservoir 204, an assay component reservoir 206, a waste reservoir 208, and all of those components to one another. As illustrated in FIG. 2A (and FIGS. 2B-2I), the plurality of paths (and the underlying one or more sets of electrodes) are shown as the series of illustrated small squares that connect testing location 210 to sample reservoir 202, a solution reservoir 204, an assay component reservoir 206, a waste reservoir 208, and all of those components to one another. Furthermore, as also illustrated in FIG. 2A (and FIGS. 2B-2I), the plurality of paths (and the underlying one or more sets of electrodes) are connected to one or more electrode contacts disposed on connection mechanism 212, which serves to connect the plurality of electrodes disposed along various portions of dielectric cartridge surface to a computing device (e.g., a controller, an analyzer, etc.). Furthermore, although connection mechanism 212 is illustrated in FIG. 2A as a plurality of electrode contacts disposed on a PCB board, connection mechanism 212 may take many other forms and configurations.

As noted above, these sets of electrodes and connection mechanism 212 facilitate transportation and manipulation of a fluid droplet containing a plurality of particles (e.g., a plurality of paramagnetic, bar-coded beads) along dielectric cartridge surface of cartridge 200. For clarity, as illustrated in FIG. 2A (and FIGS. 2B-2I), the term “dielectric cartridge surface” as used in FIG. 2A (and FIGS. 2B-2I) includes the cartridge surfaces below the illustrated sample reservoir 202, a solution reservoir 204, an assay component reservoir 206, a waste reservoir 208, and a testing location 210, as well as the illustrated paths that connects all of these components in FIGS. 2A-2D. As further illustrated in FIG. 2A (and FIGS. 2B-2D), a droplet 214 containing a plurality of particles is located on testing location 210.

In examples, the cartridge 200 and/or any components thereof may interact with a computing device, such as computing device 100 (e.g., via connection mechanism 212). As described above, a computing device 100 can be implemented as a controller, and a user of the controller can use the controller to program and/or control cartridge 200 and/or any components thereof. The cartridge 200 and/or any components thereof may communicably coupled with a controller, such as computing device 100, and may communicate with the controller by way of connection mechanism 212, as well as other connections (e.g., a wired connection, a wireless connection, or a combination thereof). Further, as described above, a controller may be configured to control various aspects of the illustrated cartridge 200 and testing protocols (e.g., assays) utilizing cartridge 200 and/or any components thereof. Although various cartridge components and arrangements of these components a are provided for explanatory purposes, and different shapes, amounts, and/or types of beads, particles, and/or components may be used.

In examples, the controller can execute a program that cause one or more components of the cartridge 200 to perform a series of events by way of a non-transitory computer-readable medium having stored program instructions. These program instructions include, for example, applying voltage and/or current to one or more electrodes near (e.g., below) the dielectric materials of dielectric cartridge surface to manipulate one or more droplets (or components thereof) along the dielectric cartridge surface, including along the illustrated plurality of paths that connect sample reservoir 202, a solution reservoir 204, an assay component reservoir 206, a waste reservoir 208, and a testing location 210, as illustrated in FIGS. 2A-2I. In some examples, the one or more electrodes may be used to transport one or more droplets between the illustrated components of FIGS. 2A-2I and/or manipulate (e.g., immobilize) the one or more droplets and/or components thereof at one more locations of the dielectric cartridge surface.

For example, certain voltages/currents amplitudes and patterns, as well as electrode placement around the surface of the dielectric cartridge surface may more effectively agitate the droplet to produce more accurate and consistent mixing (e.g., of the plurality of particles throughout the droplet) and associated assay results than other methods. For example, one or more sets of electrodes may receive a particular alternating electrical current at a particular frequency (e.g., 30 hertz) and/or voltage (e.g., 300 volts) that causes the droplet to be transported along the surface of the cartridge such that the droplet is moving at a particular transport speed such that the droplet does not reside in one location on the cartridge surface for more than a threshold amount of hold time (e.g., 200 milliseconds) during transportation. In examples, the controller may transport the droplet around the surface of the cartridge along one or more predefined paths, potentially a number of times, according to one or more of the parameters detailed above (e.g., at one or more of a particular voltage, frequency, transport speed, hold time, etc.). Further, the controller may transport the droplet around the surface of the cartridge via program instructions that include moving various fluids around the surface of the cartridge and perform various aspects of an assay, all on the surface of the cartridge and all in an automated (or largely automated) procedure.

In example embodiments, the one or more sets of electrodes may transport a droplet 214 containing a plurality of particles on the dielectric cartridge surface along the illustrated plurality of paths that connect sample reservoir 202, a solution reservoir 204, an assay component reservoir 206, a waste reservoir 208, and a testing location 210. In examples, the plurality of particles (e.g., paramagnetic, bar-coded beads) may be introduced into a droplet 214, either in a liquid suspension or dried onto a surface of the cartridge 200 and rehydrated. In one example, the plurality of particles may be suspended in buffer solution containing sucrose, removed from the suspension, and dried before being stored in assay component reservoir 206. In examples, the plurality of particles may be rehydrated with one or more solutions containing one or more components (e.g., reagents, sample, or both, among other possibilities) before being used in one or more aspects of an assay. In example embodiments, once the plurality of particles are rehydrated and/or introduced into a fluidic droplet, the droplet containing the plurality of particles may be transported from assay component reservoir 206 to sample reservoir 202 to be mixed with a sample residing in sample reservoir (e.g., a fecal sample, urine sample, blood sample, etc.).

In a further aspect, in example embodiments, the one or more sets of electrodes may transport a droplet of assay components (e.g., containing antibodies, antigens, labels, and/or other binding members) on the dielectric cartridge surface. In examples, these assay components may be introduced into a droplet, either in a liquid suspension or dried onto a surface of the cartridge 200 and rehydrated. Either way, once the plurality of particles are introduced into the droplet, a droplet containing plurality of particles may be transported from assay component reservoir 206 to sample reservoir 202 to be mixed with a sample residing in sample reservoir. Furthermore, although assay component reservoir 206 is illustrated as a single reservoir in FIG. 2A, it should be apparent to a person of ordinary skill in the art that assay component reservoir 206 may comprise multiple, separate reservoirs, each of which may contain a particular assay components or combination thereof (e.g., a particular antibodies, antigens, labels, and/or other binding members). Additionally or alternatively, although specifically illustrated in FIG. 2A, there may be multiple assay component reservoirs in cartridge 200, each with their own associated assay component and/or path on the dielectric cartridge surface.

In example embodiments, a variety of techniques can be used facilitate the dispersion of the plurality of particles, other assay components and/or the sample within the droplet. In a further aspect, these techniques may also be used to further facilitate mixing the plurality of particles, other assay components and/or the sample (e.g., in the sample reservoir 202) at various mixing speeds, patterns, etc., all of which may be controlled by the controller executing program instructions controlling the components of the cartridge 200.

In example embodiments, once the droplet containing the plurality of particles (e.g., paramagnetic, bar-coded beads), the sample, and/or other assay components is sufficiently mixed, all of these components may incubate in the sample reservoir 202 (e.g., to allow attachment of one or more assay components and/or components of the sample to attach to the paramagnetic, bar-coded beads). In example embodiments, once the incubation is complete, the plurality of particles and the attached sample and/or assay components (collectively, the “assembled particles”) may be further manipulated in the sample reservoir 202 (e.g., immobilized using an electrical current and/or a magnet). Once assembled, the fluids surrounding the plurality of particles and the attached sample and/or assay components may be removed and transported to waste reservoir 308 along dielectric cartridge surface.

In example embodiments, excess debris and/or other components may also be washed from the assembled particles, and the excess solution (and any other excess fluids) may be transported to waste reservoir 208 along dielectric cartridge surface (e.g., using one or more sets of electrodes). Once the assembled particles are completed and ready for analysis, in example embodiments, the assembled particles may be transported to a portion of the cartridge for analysis, including testing location 210. Prior to analyzing the assembled particles, one of several steps may be undertaken to improve the accuracy and precision of the analysis.

Now referring to FIG. 2B, additional components of example cartridge 200 are disclosed, which include cartridge cover 216, receiving chamber 218 (which includes receiving portion 220), actuation cap 222, and actuation mechanism 224. In examples, as illustrated in FIG. 2B, actuation cap 222 also includes pull tab 226, which may help to pull actuation cap 222 out of a receiving portion 220 of receiving chamber 218 after actuation cap 222 is inserted into (and interfacing with) the receiving portion 220 of receiving chamber 218. In a further aspect, as also illustrated in FIG. 2B, actuation cap 222 may also include retention mechanism 228, which may help to retain actuation cap 222 after actuation cap 222 is pulled out of a receiving portion 220 of receiving chamber 218. According to example embodiments, some or all of the receiving chamber 218, receiving portion 220, actuation cap 222, actuation mechanism 224, pull tab 226, and/or retention mechanism 228 may reside on cartridge cover 216 and above and/or adjacent to the dielectric cartridge surface where droplet 214 resides.

Furthermore, according to example embodiments, some or all of the receiving chamber 218, receiving portion 220, actuation cap 222, actuation mechanism 224, pull tab 226, and/or retention mechanism 228 may comprise one or more compliant materials, such as Linear Low Density Polyethylene (LLDPE) or Low Density Polyethylene (LDPE). In examples, according to example embodiments, some or all of the receiving chamber 218, receiving portion 220, actuation cap 222, actuation mechanism 224, pull tab 226, and/or retention mechanism 228 may comprise one or more compliant materials, such that the user can easily manipulate and/or contort these components (e.g., to actuate the actuation mechanism of the actuation cap 222 in the receiving portion 220 of receiving chamber 218).

Furthermore, as illustrated in FIG. 2B, droplet 214 and the associated testing location 210 of cartridge 200 is visible through cover 216. In examples, one or more components of cartridge 200 may present a magnified view of droplet 214 and/or testing location 210 of cartridge 200 (e.g., using a magnifying lens). As shown in FIG. 2B, a plurality of assembled particles are illustrated in droplet 214, which resides on the dielectric cartridge surface at testing location 210. As shown in FIG. 2B, the opening in the cover 216 above testing location 210 is circular and has a diameter and shape that, in one or more particular ratios with the droplet volume, minimizes the area of the droplet that is occluded by the opening of cover 216 during imaging. The features and others described herein improve, among other issues, imaging of the droplet 214 and the assembled particles thereof, particularly when paired with illumination that may occur from a light source illuminating the testing location 210 (e.g., from a back-and/or side-lighting light source). Other example configurations and materials are possible.

Turning to FIGS. 2C-2D, an opposing view of two embodiments of the actuation cap 222 of FIG. 2B is illustrated. As shown in FIGS. 2C-2D, actuation cap 222 includes actuation mechanism 224 and pull tab 226, but also includes protrusion 230. In examples, protrusion 230 may be actuated in a first direction by actuating actuation mechanism 224 in the first direction, and also actuated in a second direction (e.g., an opposing direction to the first direction) by actuating actuation mechanism 224 in the second direction (e.g., in the opposing direction to the first direction). For example, as illustrated in combination with FIG. 2B, a user may push actuation mechanism 224 downward toward the cartridge surface, which in turn may cause protrusion 230 to actuate in that same direction, toward the cartridge surface. In examples, when the user removes downward pressure from the actuation mechanism 224, the actuation mechanism 224 may return to its previous configuration by moving in a direction opposing the downward direction (away from the cartridge surface) and the protrusion 230 may move in the direction opposing the downward direction as well. In other examples, when the user removes downward pressure from the actuation mechanism 224, the actuation mechanism 224 may stay in its current position, but return to its previous configuration by a user applying force in a direction opposing the downward direction (pulling the actuation mechanism 224 away from the cartridge surface) and the protrusion 230 may move in the direction opposing the downward direction as well.

Furthermore, although protrusion 230 is illustrated in FIG. 2C as comprising three fins, protrusion 230 may be configured in a different structural arrangement as shown in FIG. 2D, including more or less fin structures, and/or different structural arrangements altogether. Furthermore, protrusion 230 may comprise one or more materials, including one or more compliant materials, such as Linear Low Density Polyethylene (LLDPE) or Low Density Polyethylene (LDPE). Other examples are possible.

Now referring to FIG. 2E, additional functionality of example cartridge 200 is disclosed, which includes a dispensing mechanism 232 dispensing a biological sample into the receiving chamber 218 via the receiving portion 220). In examples, dispensing mechanism 232 may include a syringe, a nozzle, and/or any other dispensing mechanisms. Certain example dispensing mechanisms have been described in, for example, U.S. patent application Ser. No. 18/476,618, which is incorporated by reference In some examples, the biological sample dispensed by dispensing mechanism 232 may include one or more of the following: (i) blood; (ii) urine; (iii) saliva; (iv) fecal matter; (v) secretion; (vi) excretion; (vii) Fine Needle Aspirate (FNA); (viii) lavage fluids; (ix) body cavity fluids; (x) semen; and (xi) bacteria. Other examples are possible.

Turning to FIG. 2F, a cross-sectional view of the components of FIG. 2E is illustrated. As illustrated in FIG. 2F, a dispensing mechanism 232 is inserted into the receiving chamber 218 via the receiving portion 220 and a dispensing mechanism tip 234 is interfacing with fluidic connection mechanism 236. As further illustrated in FIG. 2F, fluidic connection mechanism 236 includes a connection portion 238 that, if pierced and/or ruptured, would allow a biological sample residing in sample area 240 to be displaced into sample reservoir 242 (e.g., due to gravitational forces). In some examples, this connection portion 238 may comprise one or more structures that allow multiple piercing and/or rupturing by a rigid structure (e.g., a protrusion) by returning to a previous form and/or configuration after the rigid structure is removed from the connection portion 238. In examples, connection portion 238 may be made of one or more compliant materials that return to a previous form or structure after being manipulated by the rigid structure. In some examples, this connection portion 238 may comprise one or more materials and/or structures that allow only one piercing and/or rupturing by a rigid structure (e.g., a pierceable foil) and do not return to a previous form and/or configuration after the rigid structure is removed from the connection portion 238. In some examples, this rigid structure may be pierced in one or more specific ways to affect the fluid dynamics of the biological sample to be disposed on the cartridge surface. For example, in some embodiments, the rigid structure may be a pierceable foil that is cleaved (e.g., edge-to-edge cleaving) by a protrusion that is configured to cleave the pierceable foil in a manner that promotes a low pressure release of the biological sample onto the surface of the cartridge. Other examples are possible.

As also illustrated in FIG. 2F, if an excess amount of biological sample is dispensed into sample area 240, then the biological sample may flow into a first overflow area 244 and/or a second overflow area 246. In this example, if the dispensing mechanism dispenses an excess of the biological sample into sample area 240, connection portion 238 may comprise one or more materials that create a structural rigidity and integrity that creates a barrier that does not allow the biological sample to be displaced into sample reservoir 242, even if the sample area 240 is overfilled. In examples, this barrier may be created by the structural arrangement and/or materials that make up the connection portion 238 and/or other portions of the fluidic connection mechanism 236. For example, in example embodiments, this barrier may act as an overflow wall and/or dam mechanisms to meter a first portion of the biological sample (e.g., that was dispensed as bulk volume) and leave a second, reduced volume portion of the biological sample to be actuated and disposed on the surface of the cartridge. In a further aspect, in examples, this second portion may then be further metered and/or reduced to a predetermined volume that is actually disposed on the surface of the cartridge (e.g., a third volume that is a metered subset of the second volume, wherein the third volume is the volume displaced by the volume of the protrusion 230 of the actuation mechanism 234). Other examples are possible.

For example, turning to FIG. 2G, another view of the fluidic connection mechanism 236 and connection portion 238 of FIG. 2F is illustrated. In the example illustrated in FIG. 2G, connection portion 238 is illustrated as a septum with six structures that are made of one or more complaint materials (e.g., LLDPE and/or LDPE). In other examples, connection portion 238 may be configured in a different structural arrangement, including more or less structures, and/or different structural arrangements altogether. Furthermore, connection portion 238 may comprise one or more materials, including one or more compliant materials, such as Linear Low Density Polyethylene (LLDPE) or Low Density Polyethylene (LDPE). In the example illustrated in FIG. 2G, if a protrusion protruded into these six structures of the septum in a first direction, the protrusion may protrude through the septum in the first direction, and these six structures of the septum may separate due to the pressure exerted by the structure.

Turning to FIGS. 2H-2I, a cross-sectional view of the components of FIGS. 2A-2G is illustrated. As illustrated in FIGS. 2H-2I, an actuation cap 222 is inserted into the receiving chamber 218 via the receiving portion 220 and an actuation mechanism 224 is interfacing with fluidic connection mechanism 236. As further illustrated in FIGS. 2H-2I, fluidic connection mechanism 236 includes a connection portion 238 that, if pierced and/or ruptured, would allow a biological sample residing in sample area 240 to be displaced into sample reservoir 242 (e.g., due to gravitational forces). In the example illustrated in FIGS. 2H-2I, this connection portion 238 may comprises a septum made of one or more compliant materials that allow multiple piercing by the protrusion 230. In the example illustrated in FIGS. 2H-2I, if protrusion 230 is actuated in a first direction (downward, toward the cartridge surface) by actuating actuation mechanism 224 in the first direction, protrusion 230 pierces the connection portion 238 and creates a fluidic communication between the receiving chamber 218 and the sample reservoir 242 (specifically, between the sample area 240 of the receiving chamber 218 and the sample reservoir 242). Based on this fluidic communication, in examples, the biological sample residing in sample area 240 is displaced into sample reservoir 242, due to gravitational forces. By doing so, in examples, a specific volume of the biological sample is displaced into the sample reservoir (e.g., an amount defined by the volume of the sample area 240) and, because the sample is displaced into the sample reservoir 242 due to gravitational forces, there is no fluidic disturbance or volatility associated with displacing the sample into the sample reservoir 242.

Furthermore, in the example illustrated in FIGS. 2H-2I, if protrusion 230 is actuated in a second direction (upward, away from the cartridge surface) by actuating the actuation mechanism 224 in the second direction, protrusion 230 can retract away from the connection portion 238 and, if because connection portion 238 is made of one or more complaint materials, connection portion 238 may return to its previous configuration—particularly the septum of connection portion 238. In doing so, connection portion 238 may inhibit fluidic communication between the receiving chamber 218 and the sample reservoir 242 (specifically, between the sample area 240 of the receiving chamber 218 and the sample reservoir 242). By doing so, in examples, a user may dispose multiple samples into the receiving chamber 218 over a series of dispensing events and utilize the actuation mechanism to displace the multiple samples, separately, into the sample reservoir 242, at different times by leveraging and re-leveraging the relationship between protrusion 230 protruding into and retracting away from the connection portion 238. In examples, this arrangement provides a convenient, repeatable, and consistent methods of metering and disposing: (i) multiple samples into a single sample reservoir and/or onto a surface of a single cartridge; and/or (ii) multiple samples over multiple sample reservoirs and/or surfaces of multiple cartridges. In doing so, in examples, the functionality of one or more additional components of a cartridge may be realized.

For example, as shown in FIGS. 2A and 2B, after the particles are assembled, they may be disposed in a liquid (e.g., a solution from solution reservoir 204) and transported via fluidic transportation across the dielectric cartridge surface, via one or more sets of electrodes (i.e., moving the assembled particles along one or more paths of the dielectric cartridge surface), to the testing location 310.

In examples, testing location 210 provides a predetermined location for a reader to conduct the analysis and/or testing (e.g., assay testing) on the assembled particles. In example embodiments, the reader may detect, shortly after the assembled particles arrive at the testing location 210, an assay read signal corresponding to at least one of the assembled particles at the testing location 210. In some example embodiments, this detection and/or analysis may occur within a predetermined time period after the assembled particles arrive at the testing location 310 and any manipulation has been undertaken.

In an example embodiment, during analysis, one or more cameras and/or an optics system reader may be employed to capture images of the assembled particles and/or decode properties of these particles (e.g., decoding the individual bar codes of the paramagnetic, bar-coded beads). In other examples, one or more sets of electrodes and/or one or more magnets may be used to manipulate the paramagnetic, bar-coded beads while reading other parameters of the droplet containing the assembled particles and/or the assembled particles themselves

For example, to help measure the dispersion and consistency of the assembled particles in the droplet solution, an image of the droplet of solution may be generated. In examples, this image may contain a plurality of images of the droplet of solution and based on one or more attributes of this generated image, one or more parameters may be determined for the droplet and/or the components thereof. For example, the generated image may also be used to identify one or more characteristics of the individual particles in the droplet. For example, if the particles include paramagnetic beads that include one or more unique bar codes, the generated image may be used to identify one or more unique bar codes in the image corresponding to the individual particles in the transferred aliquot of solution. In example embodiments, the one or more unique bar codes identified in the generated image can also be used to determine an assay result. In example embodiments, the one or more unique bar codes identified in the generated image can also be compared to an assay result generated from another source (e.g., a reader) and/or used to determine the accuracy of the results from another source (e.g., by comparing the assay results from the reader to those determined from the generated image).

As described herein, the particles illustrated in FIGS. 2A-2I may be utilized during one or more assay procedures, including, for example, to identify a particular type and/or subset of components within a sample. In some example embodiments, each of the assembled particles includes a unique bar code. In another example, each of the assembled particles include two or more unique bar codes. In yet another example, a subset of the assembled particles may include one unique bar code and the remaining assembled particles may include two or more unique bar codes. In practice, each of these bar codes may correspond to particular information about the paramagnetic bead, the droplet of solution, and/or one or more additional parameters (including those used in an assay). For example, these unique bar codes may be utilized during one or more assay procedures to identify a particular type and/or subset of paramagnetic beads within the solution.

It should also be noted that although the particles illustrated in FIGS. 2A-2I involve paramagnetic beads, different shapes, amounts, and/or types of particles may be used.

It should also be noted that one or more concepts illustrated in FIGS. 2A-2I may be accomplished using a computing device, such as computing device 100. As described above, a computing device 100 can be implemented as a controller, and a user of the controller can use the controller to control the capturing of one or more images of the droplet of solution, as well as process the plurality of images to generate and/or annotate one or more images of the plurality of images.

In examples, the controller can execute a program that causes the controller and/or components operating therewith (e.g., a camera) to perform a series of actions by way of a non-transitory computer-readable medium having stored program instructions.

Now referring to FIG. 3, a computing system 300 configured for use with an imaging device 302 and a mobile computing device 306, according to an example embodiment. Example devices (e.g., 200) are compatible with an imaging device 302 that can read an optical signal present on a cartridge and/or a test strip. Signals may include a color or intensity of light associated with the test strip or may detect an image present on the strip that is associated with a bead (e.g., barcoded, shape, size, etc.) present on the strip. An imaging device 302 includes a computing device, such as computing device 100. It should also be readily understood that computing device 100 and the imaging device 302, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, a computing system 300 can include various components, such as the computing device 100, imaging device 302, a cloud-based assessment platform.

The imaging device 302 and/or components thereof can perform various acts and/or functions (many of which are described above). Examples of these and related features will now be described in further detail.

The imaging device 302 may collect data from a number of sources. In one example, the imaging device 302 may collect data from a database of images related to testing of samples, including one or more images of the droplets, plurality of particles, cartridges, and/or components thereof. The images may be uploaded to an assessment platform 304 and characteristics of the images may be output to a mobile computing device 306.

In an example, assessment platform 304 may collect data from one or more sensors communicably coupled to the imaging device 302, such as an imaging sensor, concerning a particular sample. In such examples, the assessment platform 304 may identify a characteristic of the droplet or a testing result and transmit instructions to the mobile computing device 306 to cause a graphical user interface to display a graphical indication of the identified characteristic and/or testing result. In some examples, the assessment platform 304 may determine a testing result by utilizing one or more of: (i) an artificial neural network, (ii) a support vector machine, (iii) a regression tree, or (iv) an ensemble of regression trees.

In another example, the imaging device 302 may collect data from one or more sensors communicably coupled to the imaging device, such as an imaging sensor, concerning a particular droplets, one or more particles, and/or cartridge. In some examples, the assessment platform 504 may determine a characteristic of the droplet and/or testing result by utilizing one or more of: (i) an artificial neural network, (ii) a support vector machine, (iii) a regression tree, or (iv) an ensemble of regression trees.

In some examples, images that are captured by the imaging device can be stored within a memory, such as a memory of computing device 100, to be subsequently analyzed.

In one example, the imaging device 302 may train a machine learning model using data associated images of droplets, one or more particles, and/or cartridges that share a characteristic with captured images of droplets, one or more particles, and/or cartridges. The machine learning model may be trained using training data that shares a characteristic and/or testing result with droplets, one or more particles, and/or cartridges to be analyzed by the imaging device. Training the machine learning model may include inputting one or more training images into the machine learning model, predicting, by the machine learning model, an outcome of a determined condition of the one or more training images, comparing the at least one outcome to the characteristic of the one or more training images, and adjusting, based on the comparison, the machine learning model.

In some examples, the training data may include labeled input images (supervised learning), partially labeled input images (semi-supervised learning), or unlabeled input images (unsupervised learning). In some examples, training may include reinforcement learning.

The machine learning model may include an artificial neural network, a support vector machine, a regression tree, an ensemble of regression trees, or some other machine learning model architecture or combination of architectures.

In some examples, the machine learning model of the imaging device 302 may be adjusted based on training such that if the outcome of a determined testing result matches the characteristic and/or testing result of the training images, the machine learning model is reinforced and if the outcome of a determined testing result does not match the characteristic of the training images, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

Once the imaging device 302 has determined a characteristic of a droplet and/or one or more particles in one or more images, the imaging device may transmit instructions that cause a computing device (e.g., the computing device 100) to display one or more graphical indications of the identified characteristic and/or the enhanced image.

In some example embodiments, the droplet and/or plurality of particles can be used for a variety of tests. For instance, these tests may include imaging of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, Cl, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

### Example Methods and Aspects

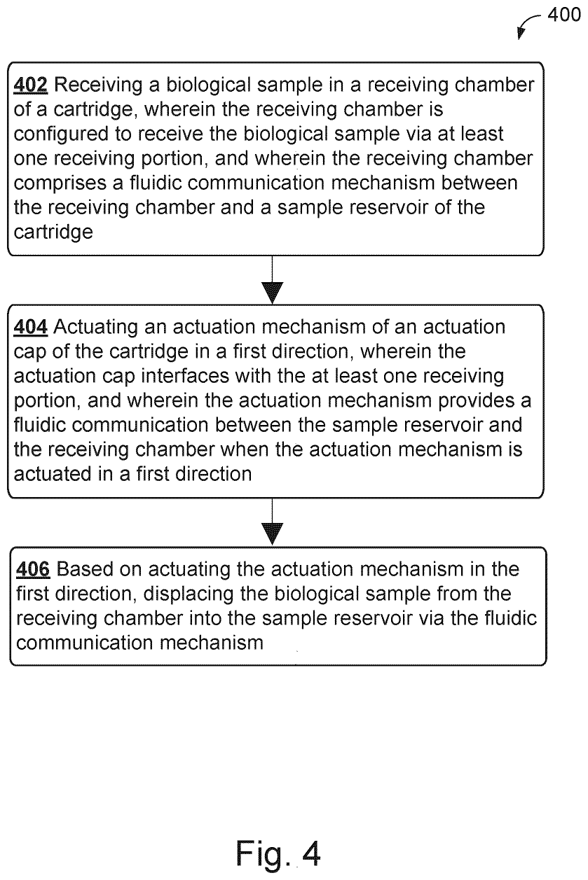

Now referring to FIG. 4, an example method of displacing a biological sample into a sample reservoir of a cartridge is disclosed.

Method 400 shown in FIG. 4 presents an example of a method that could be used with the components shown in FIGS. 1-3, for example. Further, devices or systems may be used or configured to perform logical functions presented in FIG. 3. In other examples, components of the devices and/or systems may be arranged to be adapted to, capable of, or suited for performing the functions, such as when operated in a specific manner. Method 400 may include one or more operations, functions, or actions as illustrated by one or more of blocks 402-406. Although the blocks are illustrated in a sequential order, these blocks may also be performed in parallel, and/or in a different order than those described herein.

Also, the various blocks may be combined into fewer blocks, divided into additional blocks, and/or removed based upon the desired implementation.

At block 402, method 400 involves receiving the biological sample in a receiving chamber, wherein the receiving chamber is configured to receive the biological sample via at least one receiving portion, and wherein the receiving chamber comprises a fluidic communication mechanism between the receiving chamber and the sample reservoir. In some example embodiments, the biological sample comprises one or more of the following: (i) blood; (ii) urine; (iii) saliva; (iv) fecal matter; (v) secretion; (vi) excretion; (vii) Fine Needle Aspirate (FNA); (viii) lavage fluids; (ix) body cavity fluids; (x) semen; and (xi) bacteria.

At block 404, method 400 involves actuating an actuation mechanism of an actuation cap in a first direction, wherein the actuation cap interfaces with the at least one receiving portion, and wherein the actuation mechanism provides a fluidic communication between the sample reservoir and the receiving chamber when the actuation mechanism is actuated in a first direction. In some example embodiments, the actuation cap covers the at least one receiving portion when the actuation cap interfaces with the at least one receiving portion. In some example embodiments, the actuation mechanism comprises a compressible material. In some example embodiments, the actuation mechanism comprises a manual actuation mechanism. In some example embodiments, the actuation mechanism is communicably coupled to a computing device.

At block 406, method 400 involves based on actuating the actuation mechanism in the first direction, displacing the biological sample from the receiving chamber into the sample reservoir via the fluidic communication mechanism.

In some example embodiments, the fluidic communication mechanism provides a fluidic communication between the sample reservoir and the receiving chamber. In some example embodiments, the fluidic communication mechanism comprises a piercable septum and the piercable septum comprises a compliant material. In some example embodiments, the fluidic communication mechanism provides the fluidic communication between the sample reservoir and the receiving chamber by the actuation mechanism protruding through a surface of the piercable septum when the actuation mechanism is actuated in the first direction.

In some example embodiments, the actuation mechanism restricts the fluidic communication between the sample reservoir and the receiving chamber when the actuation mechanism is actuated in a second direction. In some example embodiments, the fluidic communication mechanism provides the fluidic communication between the sample reservoir and the receiving chamber by the actuation mechanism protruding through a surface of the piercable septum when the actuation mechanism is actuated in the first direction and the fluidic communication mechanism restricts the fluidic communication between the sample reservoir and the receiving chamber by the actuation mechanism retracting from the surface of the piercable septum when the actuation mechanism is actuated in the second direction.

In some example embodiments, the fluidic communication mechanism comprises a piercable foil and the fluidic communication mechanism provides the fluidic communication between the sample reservoir and the receiving chamber by the actuation mechanism protruding through a surface of the piercable foil when the actuation mechanism is actuated in the first direction.

In some example embodiments, the cartridge of method 400 further comprises a plurality of electrodes, wherein the plurality of electrodes comprises a set of electrodes and a surface for transporting, by applying an electrical current to the set of electrodes, a droplet on the surface of the cartridge, wherein the set of electrodes is configured to transport the droplet on the surface of the cartridge along a path, and wherein the droplet comprises a plurality of particles, and wherein the surface is in fluidic communication with the sample reservoir. In example embodiments, the plurality of particles comprises at least one paramagnetic, bar-coded bead. In some embodiments, the at least one paramagnetic, bar-coded bead of the droplet comprises one or more unique bar codes. In other examples, the at least one paramagnetic, bar-coded bead of the droplet comprises at least one non-spherical, paramagnetic, bar-coded bead. In other examples, the at least one paramagnetic, bar-coded bead of the droplet comprises at least one spherical, paramagnetic, bar-coded bead. In some examples, the at least one paramagnetic, bar-coded bead of the droplet is between approximately 0.1 and 100 microns in size. In some examples, the droplet further comprises a solution for washing the at least one paramagnetic, bar-coded bead of the droplet. In some examples, the droplet further comprises a read buffer solution.

In some examples, the first surface of the cartridge comprises a dielectric material. In some examples, the first electrical current comprises a direct electrical current.

In some examples, the second surface of the cartridge comprises a dielectric material. In some examples, the first electrical current comprises a direct electrical current. In some examples, the first electrical current comprises an alternating electrical current.

In some examples, method 400 further comprises analyzing the droplet, wherein analyzing the droplet comprises performing one or more assay procedures on the droplet, and wherein, during the one or more assay procedures, determining a parameter of the droplet. In some examples, determining a parameter of the droplet comprises identifying a particular feature of the plurality of particles of the droplet, and wherein the plurality of particles comprises at least one paramagnetic, bar-coded bead. In other examples, determining a parameter of the droplet comprises identifying a particular feature of the at least one paramagnetic, bar-coded bead of the droplet.

In some examples, analyzing the droplet comprises generating an image of the droplet on the surface of the cartridge, wherein the image comprises an image of the plurality of particles of the droplet, and wherein the plurality of particles comprises at least one paramagnetic, bar-coded bead and, based on the generated image, determining a parameter of the droplet. In some examples, determining a parameter of the droplet comprises comparing the generated image of the droplet to a previously generated image of the droplet. In some examples, analyzing the droplet comprises generating a composite image of the droplet on the surface of the cartridge, wherein the composite image comprises a plurality of images of the at least one paramagnetic, bar-coded bead of the droplet and, based on the generated composite image, determining a parameter of the droplet. In some examples, the method 400 includes transmitting instructions that cause a graphical user interface to display a graphical representation of the determined parameter of the droplet. In some examples, analyzing the droplet comprises performing a plurality of assay procedures on the droplet, and wherein, during the one or more assay procedures, determining the presence of one or more analytes adhered to the plurality of particles of the droplet, and wherein the plurality of particles comprises at least one paramagnetic, bar-coded bead.

In some examples, the receiving chamber is configured to receive a first volume of the biological sample via at least one receiving portion and the actuation mechanism provides a fluidic communication between the sample reservoir and the receiving chamber for a second volume of the biological sample when the actuation mechanism is actuated in the first direction, wherein the second volume comprises a predetermined volume of the first volume.

In one aspect, a tangible, non-transitory computer-readable medium, having stored thereon program instructions that, upon execution by a controller, cause a controller to perform a set of operations is described. In a further aspect, the set of operations includes: (i) receiving a first volume of a biological sample in a receiving chamber of a cartridge, wherein the receiving chamber is configured to receive the first volume of the biological sample via at least one receiving portion, and wherein the receiving chamber comprises a fluidic communication mechanism between the receiving chamber and a sample reservoir of the cartridge; (ii) actuating an actuation mechanism of an actuation cap of the cartridge in a first direction, wherein the actuation cap interfaces with the at least one receiving portion, and wherein the actuation mechanism provides a fluidic communication between the sample reservoir and the receiving chamber when the actuation mechanism is actuated in a first direction; and (iii) based on actuating the actuation mechanism in the first direction, displacing a second volume of the biological sample from the receiving chamber into the sample reservoir via the fluidic communication mechanism wherein the second volume comprises a portion of the first volume.

In another aspect, an example cartridge is disclosed. In a further aspect, the cartridge includes: (i) a sample reservoir; (ii) a receiving chamber, wherein the receiving chamber is configured to receive a biological sample via at least one receiving portion, and wherein the receiving chamber comprises a fluidic communication mechanism between the receiving chamber and the sample reservoir; and (iii) an actuation cap, wherein the actuation cap interfaces with the at least one receiving portion, and wherein the actuation cap comprises an actuation mechanism, and wherein the actuation mechanism provides a fluidic communication between the sample reservoir and the receiving chamber when the actuation mechanism is actuated in a first direction.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A cartridge comprising:
a sample reservoir;
a receiving chamber, wherein the receiving chamber is configured to receive a biological sample via at least one receiving portion, and wherein the receiving chamber comprises a fluidic communication mechanism between the receiving chamber and the sample reservoir; and
an actuation cap, wherein the actuation cap interfaces with the at least one receiving portion, and wherein the actuation cap comprises an actuation mechanism, and wherein the actuation mechanism provides a fluidic communication between the sample reservoir and the receiving chamber when the actuation mechanism is actuated in a first direction.

2. The cartridge of claim 1, wherein the biological sample comprises one or more of the following: (i) blood; (ii) urine; (iii) saliva; (iv) fecal matter; (v) secretion; (vi) excretion; (vii) Fine Needle Aspirate (FNA); (viii) lavage fluids; (ix) body cavity fluids; (x) semen; and (xi) bacteria.

3. The cartridge of claim 1, wherein the fluidic communication mechanism provides a fluidic communication between the sample reservoir and the receiving chamber.

4. The cartridge of claim 1, wherein the fluidic communication mechanism comprises a pierceable septum, and wherein the pierceable septum comprises a compliant material.

5. The cartridge of claim 4, wherein the fluidic communication mechanism provides the fluidic communication between the sample reservoir and the receiving chamber by the actuation mechanism protruding through a surface of the pierceable septum when the actuation mechanism is actuated in the first direction.

6. The cartridge of claim 4, wherein the actuation mechanism restricts the fluidic communication between the sample reservoir and the receiving chamber when the actuation mechanism is actuated in a second direction.

7. The cartridge of claim 6, wherein the fluidic communication mechanism provides the fluidic communication between the sample reservoir and the receiving chamber by the actuation mechanism protruding through a surface of the pierceable septum when the actuation mechanism is actuated in the first direction, and wherein the fluidic communication mechanism restricts the fluidic communication between the sample reservoir and the receiving chamber by the actuation mechanism retracting from the surface of the pierceable septum when the actuation mechanism is actuated in the second direction.

8. The cartridge of claim 1, wherein the fluidic communication mechanism comprises a pierceable foil, and wherein the fluidic communication mechanism provides the fluidic communication between the sample reservoir and the receiving chamber by the actuation mechanism protruding through a surface of the pierceable foil when the actuation mechanism is actuated in the first direction.

9. The cartridge of claim 1, wherein the actuation cap covers the at least one receiving portion when the actuation cap interfaces with the at least one receiving portion.

10. The cartridge of claim 1, wherein the actuation mechanism comprises a compressible material.

11. The cartridge of claim 1, wherein the actuation mechanism comprises a manual actuation mechanism.

12. The cartridge of claim 1, wherein the receiving chamber is configured to receive a first volume of the biological sample via at least one receiving portion, and wherein the actuation mechanism provides a fluidic communication between the sample reservoir and the receiving chamber for a second volume of the biological sample when the actuation mechanism is actuated in the first direction, and wherein the second volume comprises a predetermined volume of the first volume.

13. The cartridge of claim 1, wherein the actuation mechanism is communicably coupled to a computing device.

14. The cartridge of claim 1, wherein the cartridge further comprises:
a plurality of electrodes, wherein the plurality of electrodes comprises a set of electrodes; and
a surface for transporting, by applying an electrical current to the set of electrodes, a droplet on the surface of the cartridge, wherein the set of electrodes is configured to transport the droplet on the surface of the cartridge along a path, and wherein the droplet comprises a plurality of particles, and wherein the surface is in fluidic communication with the sample reservoir.

15. The cartridge of claim 13, wherein the droplet comprises a plurality of particles, and wherein the plurality of particles comprises at least one paramagnetic, bar-coded bead.

16. The cartridge of claim 14, wherein the at least one paramagnetic, bar-coded bead of the droplet comprises one or more unique bar codes.

17. The cartridge of claim 14, wherein the at least one paramagnetic, bar-coded bead of the droplet comprises at least one spherical, paramagnetic, bar-coded bead.

18. The cartridge of claim 13, wherein the surface comprises a dielectric material, and wherein the electrical current comprises at least one of: (i) a direct electrical current; and (ii) an alternating electrical current.

19. A method for displacing a biological sample into a sample reservoir of a cartridge, wherein the method comprises:
receiving the biological sample in a receiving chamber, wherein the receiving chamber is configured to receive the biological sample via at least one receiving portion, and wherein the receiving chamber comprises a fluidic communication mechanism between the receiving chamber and the sample reservoir;
actuating an actuation mechanism of an actuation cap in a first direction, wherein the actuation cap interfaces with the at least one receiving portion, and wherein the actuation mechanism provides a fluidic communication between the sample reservoir and the receiving chamber when the actuation mechanism is actuated in a first direction; and
based on actuating the actuation mechanism in the first direction, displacing the biological sample from the receiving chamber into the sample reservoir via the fluidic communication mechanism.

20. A tangible, non-transitory computer-readable medium, having stored thereon program instructions that, upon execution by a controller, cause a controller to perform a set of operations comprising:
receiving a first volume of a biological sample in a receiving chamber of a cartridge, wherein the receiving chamber is configured to receive the first volume of the biological sample via at least one receiving portion, and wherein the receiving chamber comprises a fluidic communication mechanism between the receiving chamber and a sample reservoir of the cartridge;
actuating an actuation mechanism of an actuation cap of the cartridge in a first direction, wherein the actuation cap interfaces with the at least one receiving portion, and wherein the actuation mechanism provides a fluidic communication between the sample reservoir and the receiving chamber when the actuation mechanism is actuated in a first direction; and
based on actuating the actuation mechanism in the first direction, displacing a second volume of the biological sample from the receiving chamber into the sample reservoir via the fluidic communication mechanism, wherein the second volume comprises a portion of the first volume.
